(19) United States
(12) Patent Application Publication
(10) Pub. No.: US 2018/0270572 A1
(43) Pub. Date: Sep. 20, 2018

(54) TRANSDUCER MODULE AND SOUND DELIVERY DEVICE HAVING THE SAME

(71) Applicant: Alwin Co., Ltd., Apia (WS)

(72) Inventor: CHI-HSUEH RICHARD, San Jose, CA (US)

(21) Appl. No.: 15/768,567

(22) PCT Filed: Oct. 20, 2016
(86) PCT No.: PCT/US16/57780

§ 371 Date: Apr. 16, 2018

Related U.S. Application Data
(60) Provisional application No. 62/243,956, filed on Oct. 20, 2015.

(51) Int. Cl. H04R 1/40

(52) U.S. Cl. CPC H04R 1/406; H04R 1/1008

(57) ABSTRACT

A transducer module includes a signal input unit and at least one transducer. The signal input unit receives an audio signal and transmit the audio signal to the transducer. The transducer comprises a coil configured for generating a variable magnetic field corresponding to the audio signal. A sound delivery device comprises a signal input unit, a signal processing unit, at least one transducer and at least one speaker. The signal input unit receives an audio signal and transmits the audio signal to the signal processing unit. The signal processing unit is configured to process the audio signal and transmit the processed audio signal to the transducer and speaker. The transducer comprises a coil configured for generating a variable magnetic field corresponding to the processed audio signal, and the speaker generates a sound corresponding to the processed audio signal.

### CROSS-REFERENCE TO RELATED APPLICATIONS

This application is the National Stage of International Application No. PCT/US16/57780 filed on Oct. 20, 2016, which claims benefits of U.S. provisional application No. 62/243,956 filed on Oct. 20, 2015, the entirety of which are incorporated herein by reference.

### FIELD

The subject matter herein generally relates to a hearing assistance technology, and particularly to a transducer module and a sound delivery device.

### BACKGROUND

Hearing loss affects quality of life. It may be caused by aging, noise exposure, infections, physical trauma, neurological disorders, or developmental defects. To compensate for the loss of hearing acuity, various types of hearing aid devices or personal sound amplification devices have been developed. Such devices amplify sound for the users, such as behind-the-ear aids, in-the-ear aids, partically or completely in-the-canal aids. However, most conventional hearing aids do not provide locational information of sound in the environment, so difficulties at cocktail parties still exist. Conventional devices may also result in the occlusion effect, due to sound vibrations being conducted through bone and reverberating off an object filling the ear canal.

For over a century, scientists have studied the neurophysiological effect of variable magnetic field. It's been widely known that many neurological disorders, such as depression, schizophrenia, neuropathic pain, and tinnitus may be treated by transcranial magnetic stimulation. For example, U.S. Food and Drug Administration has approved a transcranial magnetic stimulator under product code OBP through 510(k) process. Nevertheless, the market need of a sound delivery device with variable magnetic field remains unmet.

Solutions are provided by the present disclosures and are not to be limited to the particular embodiments described. The extent of applications may not be exhaustively described within the scope of present disclosure.

### BRIEF DESCRIPTION OF THE DRAWINGS

Implementations of the present technology will now be described, by way of example only, with reference to the attached figures.

FIG. 1A, FIG. 1B, and FIG. 1C are schematic diagrams of embodiments of a transducer module.

FIG. 2A. FIG. 2B. FIG. 2C. and FIG. 2D are schematic illustrations of a transducer of the present disclosure, embodied as a coil. FIG. 2A is a schematic illustration of a spiral-wound flat coil; FIG. 2B is a schematic illustration of a bifilar flat coil; FIG. 2C is a schematic illustration of a loose spring coil; and FIG. 2D is a schematic illustration of a tight spring coil.

FIG. 3A, FIG. 3B, and FIG. 3C are schematic diagrams of embodiments of a sound delivery device.

FIG. 4 is a schematic illustration of a sound delivery device comprising a wearable headband housing.

FIG. 5 is a schematic illustration of a sound delivery device comprising a wearable spectacle frame housing.

FIG. 6 is a schematic illustration of a sound delivery device comprising a wearable helmet housing.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

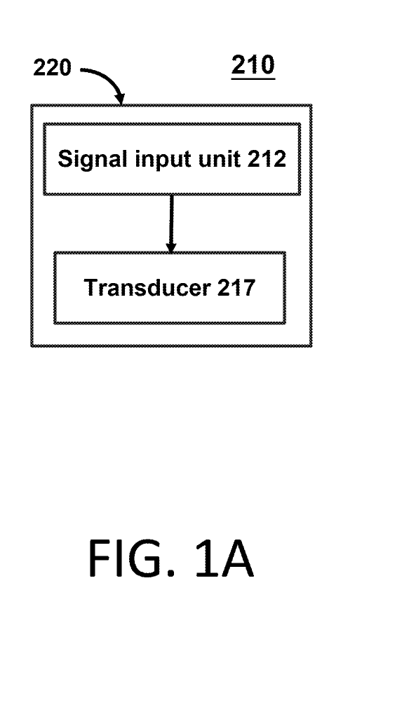

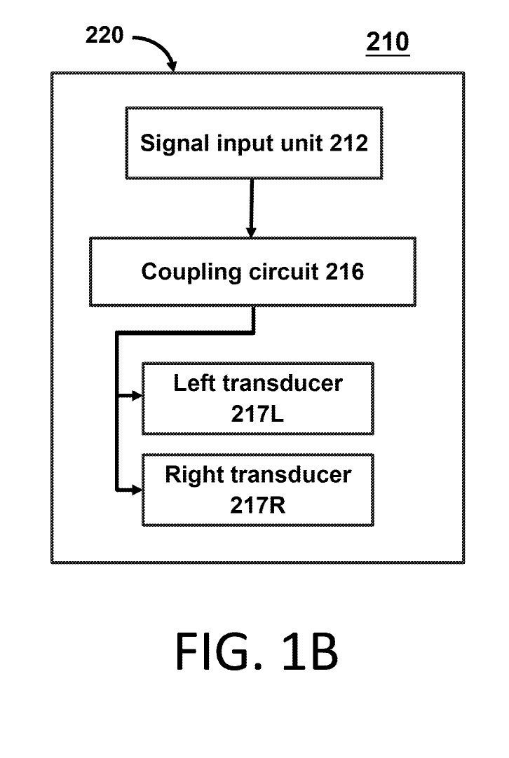

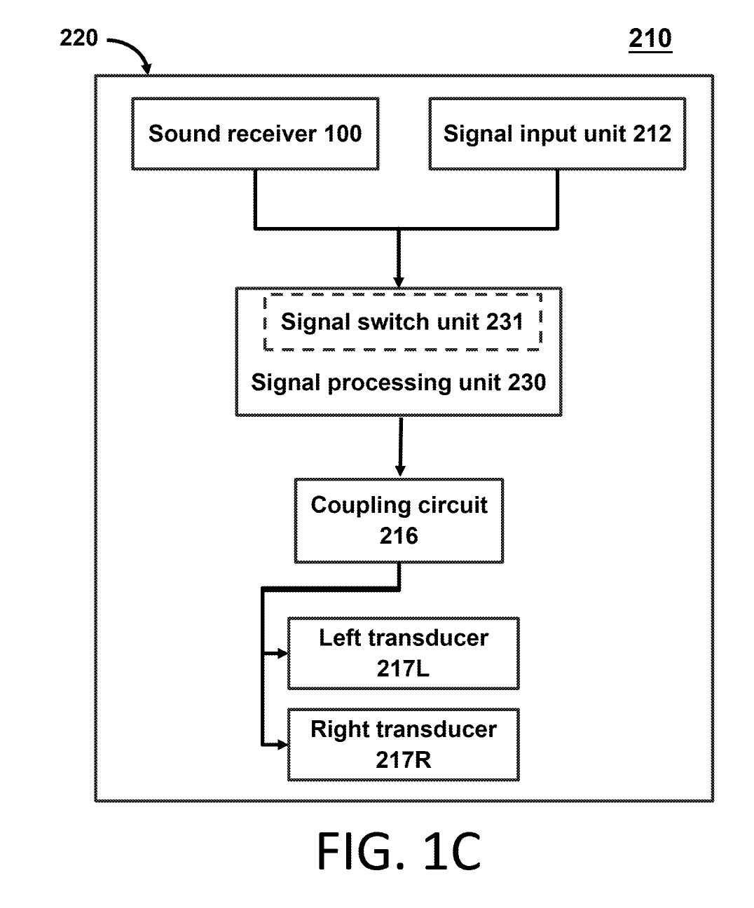

A transducer module receives signals representing ambient sound or audio signals and generates variable magnetic field. Referring to FIG. 1A, the transducer module 210 may comprise a signal input unit 212, a transducer 217, and a housing 220. The transducer module 210 may receive an audio signal from the signal input unit 212. Then, the received audio signal may be directly transmitted to the transducer 217 to generate variable magnetic field. The housing 220 is configured to accommodate the signal input unit 212 and the transducer 217. The housing 220 may be compatible to a headphone, earphone, or the like, so that the combination of a transducer module 210 and an ordinary headphone may be able to deliver sound and variable magnetic field.

The signal input unit 212 is configured to receive signals and convey the signals to other electronic components of the transducer module 210. A signal input unit 212 may be a microphone, an audio port, or a wireless communication module. A microphone may be embodied as a condenser microphone, a ribbon microphone, a piezoelectric microphone, or a silicon microphone. An audio port may be a phone connector, a DIN connector, a BNC connector, an XLR connector, an RCA connector, or a TOSLINK connector. A wireless communication module is configured to receive wireless signals and convert the signals into audio signals adapted to successive components. A wireless communication module may be a BLUETOOTH module, a WI-FI module, or a ZIGBEE module.

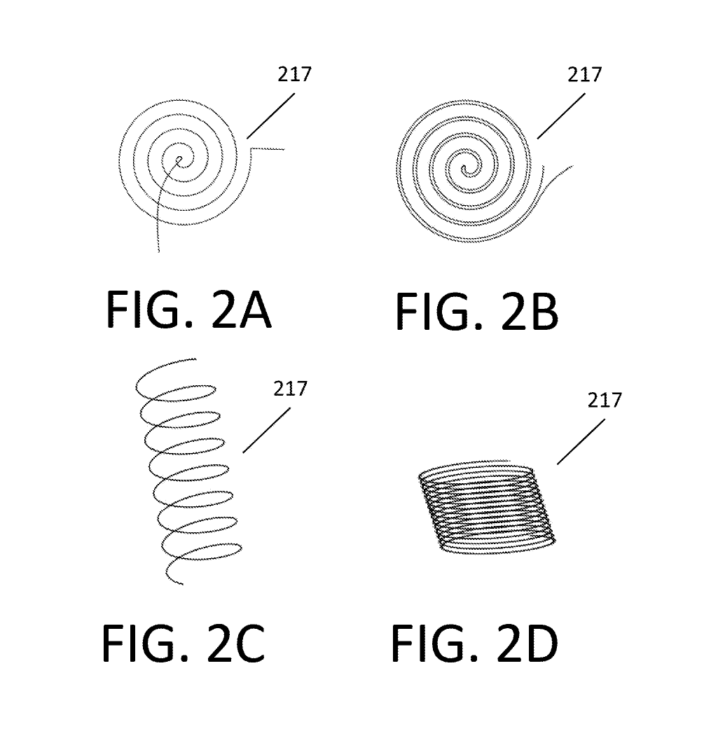

The transducer 217 is configured to convert electrical power into a magnetic field. A transducer 217 may be embodied as a coil. The coil may be an insulated wire wound in various forms with different winding types. The insulated wire may be an insulated copper wire, an insulated copper wire, or an insulated silver wire. As shown in FIGS. 2A, 2B, 2C, and 2D, the transducer 217 may be a flat coil wound in spiral form (FIG. 2A) or in bifilar form (FIG. 2B), or as a spring coil with loose turns (FIG. 2C), or a spring coil with tight turns (FIG. 2D). Although the embodiments of the coils are substantially circular, the shape of coil winding may also be triangular, rectangular, polygonal, or elliptical. In some embodiments, the planes formed by each of the turns in a transducer 217 may be approximately in parallel to each other so that the magnetic field may accumulate without additional electric current. In one embodiment, the coil comprises three hundred turns. In some embodiments, the diameter of the coil is 1-5 centimeters. Preferably, the diameter of the coil is 3 centimeters. In some embodiments, the working current carried by the coil is in a range of 0-0.25 milliamperes. In one embodiment, the electrical resistance of the coil is about 1800 ohms. The magnetic field generated by the transducer may be approximately between 0 microtesla to 0.02 microtesla.

Moreover, the transducer 217 may comprise a left transducer 217L and a right transducer 217R. The signal input unit 212 may deliver audio signal to the pair of transducers in a crossed fashion, thus the left transducer 217L may receive an audio signal from right channel and the right transducer 217R may receive an audio signal from left channel.

Referring to FIG. 1B, the transducer module 210 may comprise a signal input unit 212, a coupling circuit 216, a left transducer 217L, a right transducer 217R, and a housing 220. The coupling circuit 216 is electrically connected to the signal input unit 212 and is configured to couple the electrical characteristics of the transducer 217 to other electronic components. For instance, when the transducer module 210 works together with an earphone, the coupling circuit 216 may couple the electrical characteristics of the transducer 217 with the electrical characteristics of the speakers of the earphone. The coupling circuit 216 may be embodied as a resistor-capacitor circuit (RC circuit), a resistor-inductor circuit (RL circuit), or an RLC circuit. In some embodiments, the coupling circuit 216 may be a complicated circuit architecture to meet specific requirement of frequency response. In some embodiments, the capacitance of the coupling circuit 216 is 400 picofarads. As a result, the magnetic field generated by the transducers is approximately 0.001 second to 0.05 second later than the sound produced by the speakers. Also, a coupling circuit 216 may be configured to make a phase shift of the input audio signals, so that the audio signals received by transducers 217 may have a designated phase delay. Other features of the transducer module 210 can refer to or arise from abovementioned paragraphs and are not described here in detail.

Referring to FIG. 1C, the transducer module 210 may comprise a sound receiver 100, a signal input unit 212, a signal switch unit 231, a signal processing unit 230, a coupling circuit 216, a left transducer 217L, a right transducer 217R, and a housing 220. The housing 220 is configured to accommodate the sound receiver 100, the signal input unit 212, the signal switch unit 231, the signal processing unit 230, the coupling circuit 216, the left transducer 217L, and the right transducer 217R. The housing 220 may be wearable. Descriptions of the a signal input unit 212, the coupling circuit 216, and the transducer 217 of the transducer module 210 can be found in abovementioned paragraphs and are not described here in detail.

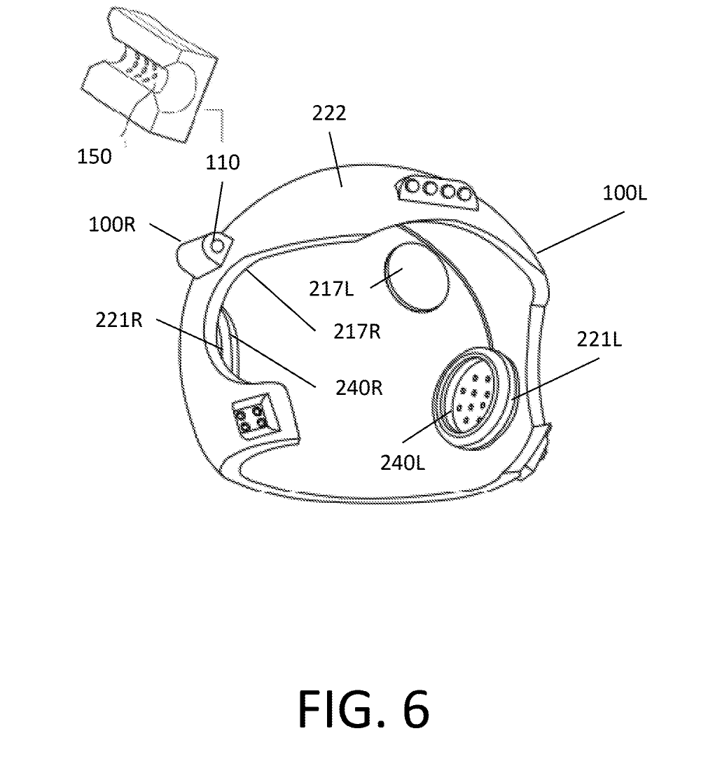

The sound receiver 100 is configured to receive ambient sound and convert the sound into audio signals. The audio signals may be transmitted from the sound receiver 100 to the signal processing unit 230. The sound receiver 100 may comprise a sound collecting structure for collecting sound from sound sources and a microphone for converting the collected sound into audio signals. As shown in FIG. 6, a sound receiver 100R comprises a sound collecting structure 110 and a microphone 150. The microphone of the sound receiver 100 may be embodied as a condenser microphone, a ribbon microphone, a piezoelectric microphone, or a silicon microphone.

The signal processing unit 230 is configured to receive electrical signals from the sound receiver 100 and/or the signal input unit 212. The signal processing unit 230 may perform functions for adequate sound delivery quality, such as mixing, amplifying, filtering, noise cancellation, phase shifting, or enhancement. The signal processing unit 230 may comprise analogue processing components, for example, an operational amplifier, or may comprise digital processing components, for example, an audio processing integrated circuit. The electrical signals may be analog electrical signals or digital electrical signals. The signal processing unit 230 may be an electrical circuit comprising operational amplifiers, capacitors, and transistors or may be integrated as a single chip in package. Also, a signal processing unit 230 may have mixing function to adequately mix the audio signals, for example, from an audio port and from a sound receiver. Furthermore, a signal processing unit 230 may flip the audio signals transmitted to bilateral transducers 217.

The signal switch unit 231 is configured to change the signal input source or to change the mode of signal input. For example, a user may select a certain mode to receive the audio signal mainly from an audio port, or to receive the audio signal mainly from a microphone. The signal switch unit 231 may be embodied as an electromagnetic relay or an optical relay. Also, the signal switch unit 231 may be integrated in the signal processing unit 230.

The processed signals may be transmitted to the coupling circuit 216, and then to the left transducer 217L and the right transducer 217R. Variable magnetic field may thus be generated by the left transducer 217L and the right transducer 217R corresponding to the signals processed by the signal processing unit 230.

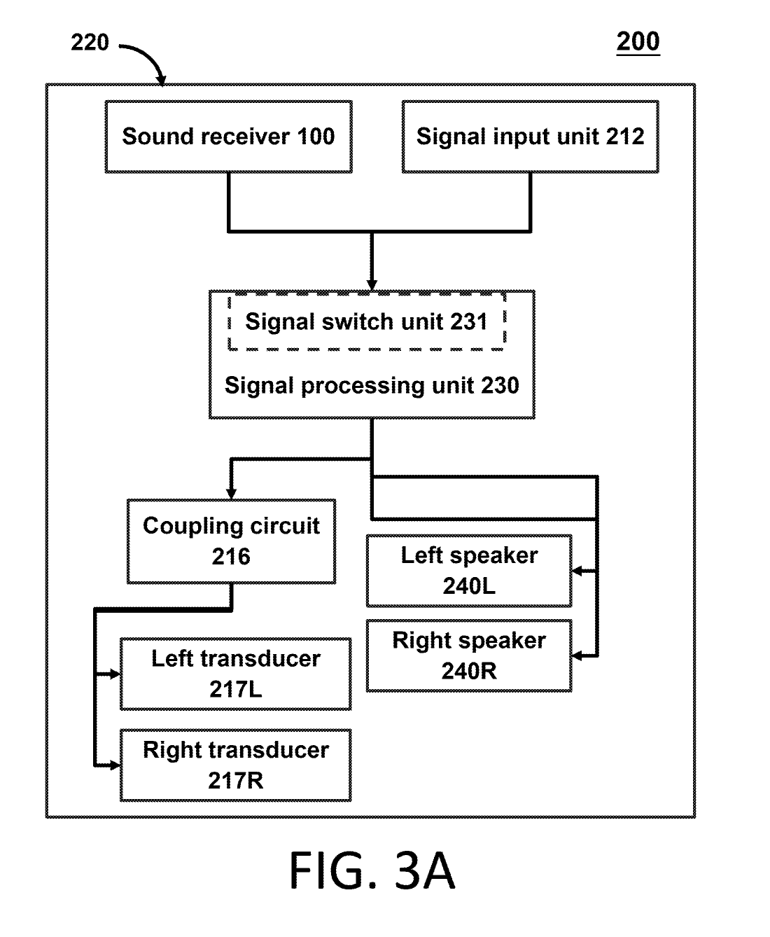

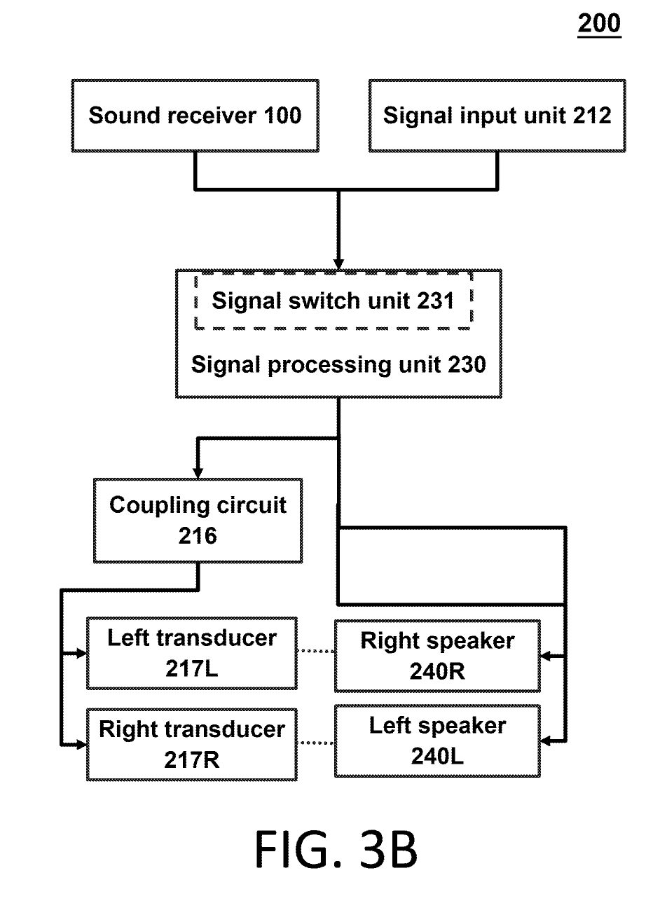

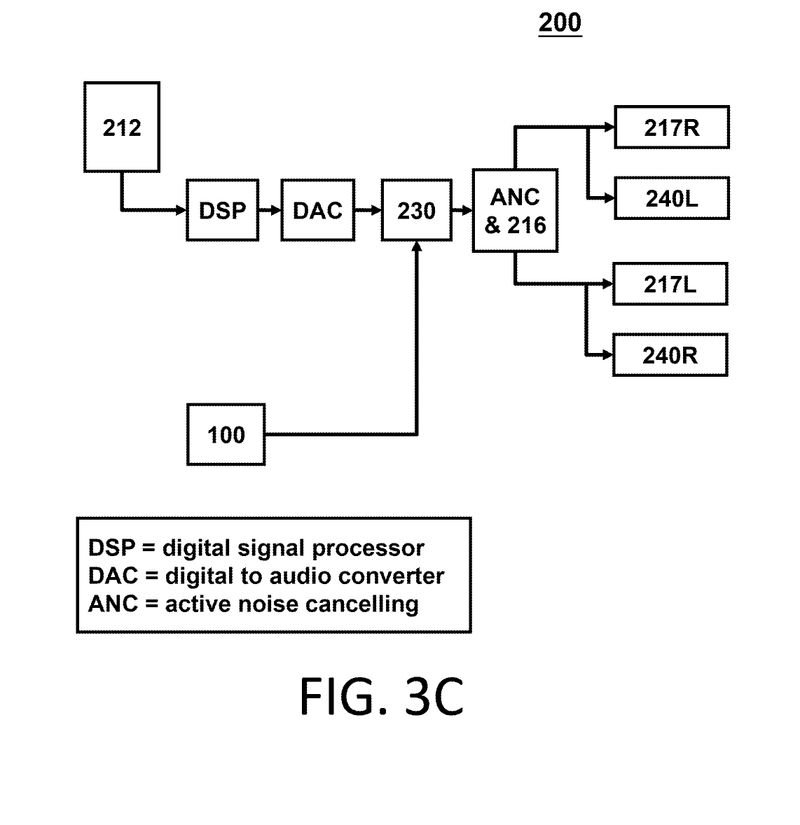

A sound delivery device is configured to receive audio signals and deliver both sound and variable magnetic field to an individual. In one embodiment as illustrated in FIG. 3A, a sound delivery device 200 comprises a sound receiver 100, a signal input unit 212, a signal switch unit 231, a signal processing unit 230, a coupling circuit 216, a transducer 217, a speaker 240, and a housing 220.

The sound receiver 100 is configured to receive ambient sound and convert the sound into audio signals. The sound receiver 100 may comprise a sound collecting structure for collecting sound from all sources and a microphone for converting sound into electrical signals. As shown in FIG. 6, a sound receiver 100R comprises a sound collecting structure 110 and a microphone 150. The microphone may be embodied as a condenser microphone, a ribbon microphone, a piezoelectric microphone, or a silicon microphone.

The signal input unit 212 is configured to receive signals and convey the signals to other electronic components of the sound delivery device 200. The signal input unit 212 may be a microphone, an audio port, or a wireless communication module. A microphone may be embodied as a condenser microphone, a ribbon microphone, a piezoelectric microphone, or a silicon microphone. An audio port may be a phone connector, a DIN connector, a BNC connector, a XLR connector, a RCA connector, or a TOSLINK connector. The wireless communication module is configured to receive wireless signals and convert the signals into audio signals adapted to successive components. The wireless communication module may be a BLUETOOTH module, a WI-FI module, or a ZIGBEE module.

A signal switch unit 231 is configured to change the signal input source or to change the mode of signal input. For example, a user may select a certain mode to receive the audio signal mainly from an audio port, or to receive the audio signal mainly from a microphone. The signal switch unit 231 may be an electromagnetic relay or an optical relay. Also, the signal switch unit may be integrated in a signal processing unit 230.

The signal processing unit 230 is configured to receive electrical signals from the sound receiver 100 and/or the signal input unit 212, and the signal processing unit 230 may perform functions for adequate sound delivery quality, such as mixing, amplifying, filtering, noise cancellation, phase shifting, or enhancement. The signal processing unit 230 may comprise analogue processing components, for example, an operational amplifier, or may comprise digital processing components, for example, an audio processing integrated circuit. The electrical signals may be analog electrical signals or digital electrical signals. The signal processing unit 230 may be an electrical circuit comprising operational amplifiers, capacitors, and transistors or may be integrated as a single chip in package. Also, the signal processing unit 230 may have mixing function to adequately mix the audio signals, for example, from both the sound receiver 100 and an audio port of the signal input unit 212. Furthermore, when the transducer 217 comprises a left transducer 217L and a right transducer 217R and the speaker 240 comprises a left speaker 240L and a right speaker 240R, the signal processing unit 230 may flip the audio signals transmitted to bilateral transducers 217. The left transducer 217L may thus receive the same signal as the right speaker 240R, and the right transducer 217R may receive the same signal as the left speaker 240L, as shown in FIG. 3B.

The coupling circuit 216 is electrically connected to the signal processing unit 230 and the transducer 217, and the coupling circuit 216 is configured to couple the electrical characteristics of the transducer 217 with the electrical characteristics of the rest of the components such as the speaker 240. A coupling circuit 216 may be embodied as a resistor-capacitor circuit (RC circuit), a resistor-inductor circuit (RL circuit), or an RLC circuit. In some embodiments, a coupling circuit 216 may be a complicated circuit architecture to meet specific requirement of frequency response. In some embodiments, the capacitance of the coupling circuit 216 is 400 picofarads. As a result, the magnetic field generated by the transducers is approximately 0.001 second to 0.05 second later than the sound produced by the speakers. Also, a coupling circuit 216 may be configured to make a phase shift so that the audio signals received by transducers 217 may have a designated phase delay compared to the audio signal received by the speakers 240.

A transducer 217 is configured to convert electrical power into magnetic field. A transducer 217 may be embodied as a coil. The coil may be an insulated wire wound in various forms with different winding types. The insulated wire may be an insulated copper wire, an insulated copper wire, or an insulated silver wire. The coils may be circular, or may be triangular, rectangular, polygonal, or elliptical. As illustrated in FIGS. 2A, 2B. 2C, and 2D, a transducer 217 may be a flat coil wound in spiral form (FIG. 2A) or bifilar form (FIG. 2B), or as a spring coil with loose turns (FIG. 2C) or with tight turns (FIG. 2D). In some embodiments, the planes formed by each of the turns in a transducer 217 may be substantially in parallel with each other so that the magnetic field may accumulate without additional electric current. In one embodiment, the coil comprises three hundred turns. In some embodiments, the diameter of the coil is 1-5 centimeters. Preferably, the diameter of the coil is 3 centimeters. In some embodiments, the working current carried by the coil is in a range of 0-0.25 milliamperes.

In one embodiment, the electrical resistance of the coil is about 1800 ohms. The magnetic field generated by the transducer may be approximately between 0 microtesla to 0.02 microtesla. Also, a transducer 217 may be embodied as a coil with a diameter larger than the diameter of the coil in the speaker 240, the larger transducer 217 producing a larger effective area.

The speaker 240 is configured to convert audio signals into sound. The speaker 240 may be a moving-coil speaker, an electrostatic speaker, an electret speaker, or an orthodynamic speaker. The electrical resistance of the speaker 240 may be around 50 ohms. In some embodiments, a pair of speakers 240 are presented in the sound delivery device 200, and each speaker 240 may be integrated in an auricular part 221 of a housing 220.

In one embodiment, as illustrated in FIG. 3C, a sound delivery device 200 comprises a sound receiver 100, a signal input unit 212, a signal processing unit 230, a coupling circuit 216, a left transducer 217L, a right transducer 217R, a left speaker 240L, and a right speaker 240R. Digital signals are input by a signal input unit 212, and then processed by a digital signal processor (DSP) and a digital to audio converter (DAC). The DAC-converted audio signal corresponding to the input digital signals may be mixed with a second audio signal provided by the sound receiver 100 by the signal processing unit 230. The signal processing unit 230 may also process the DAC-converted audio signal and the second audio signal by other means, such as amplifying, filtering, noise cancellation, phase shifting, or enhancement. The processed audio signals may be denoised by a active noise cancelling (ANC) unit, then transmitted to the coupling circuit 216. A left audio signal is conveyed to the left speaker 240L to generate one sound and the right transducer 217R to generate one variable magnetic field, while a right audio signal is conveyed to the right speaker 240R to generate another sound and the left transducer 217L to generate another variable magnetic field.

In some embodiments, the coupling circuit 216 makes a phase shift of the processed audio signals, thus the audio signals received by transducers 217 may have a designated phase delay compared to the audio signal received by the speakers 240. That is, for audio signals processed by the signal processing unit 230, the variable magnetic field generated by the transducer 217 corresponding to the audio signals may be later than the sound generated by the speaker 240 corresponding to the same audio signals. In some embodiments, the generating time of the variable magnetic field is later than the generating time of the sound by 0.001-0.05 seconds. In certain embodiment, the generating time of the variable magnetic field is later than the generating time of the sound by 0.0125 seconds.

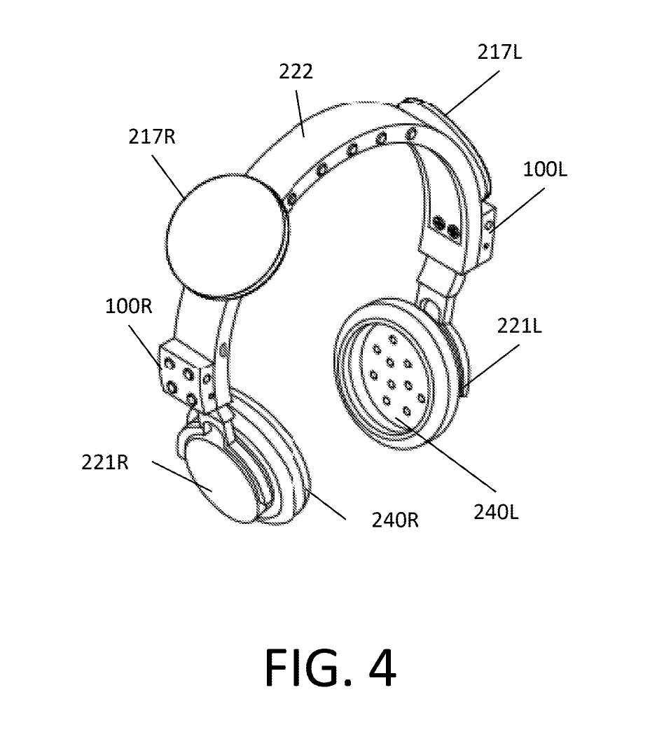

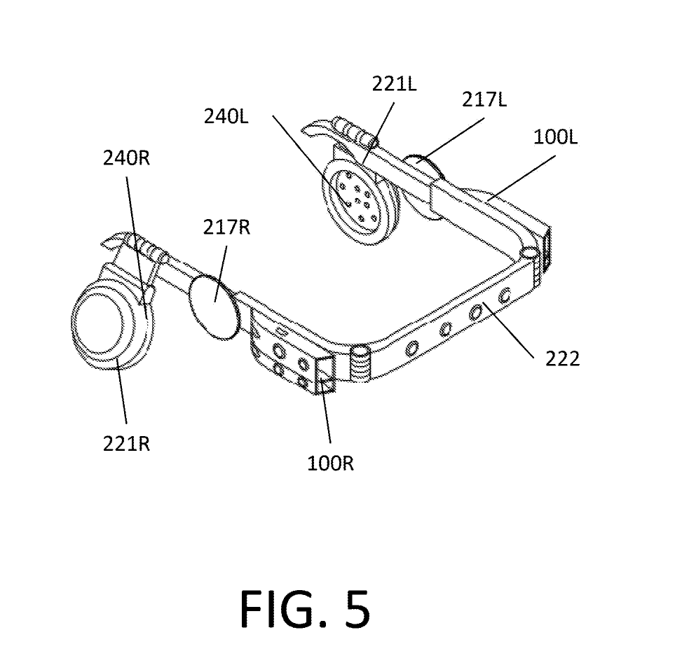

The housing 220 accommodates the abovementioned components of the sound delivery device 200 and provides a mounting which is wearable on user's head or ear. The housing 220 may comprise at least an auricular part 221 and a wearable part 222. The wearable part 222 stabilizes the sound delivery device 200 on a user's head. In some embodiments, the transducer 217 may comprise a left transducer 217L and a right transducer 217R and the speaker 240 may comprise a left speaker 240L and a right speaker 240R. In that case, the housing 220 may comprise a left auricular part 221L, a right auricular part 221R, and a wearable part 222. For example, a wearable part 222 of a housing 220 may be a headband (FIG. 4), a spectacle frame (FIG. 5), or a helmet (FIG. 6). In some embodiments, the left sound receiver 100L may receive ambient sound as left audio signal and then the audio signal is conveyed to the left speaker 240L and the right transducer 217R while the right sound receiver 100R may receive ambient sound as right audio signal and then the right audio signal is conveyed to the right speaker 240R and the left transducer 217L.

In an embodiment, a sound delivery device 200 may be configured to process audio signals and to deliver sound and variable magnetic field. A sound delivery device 200 may comprise a sound receiver 100, a signal input unit 212, a signal processing unit 230, a speaker 240, a transducer 217, and a housing 220. The audio signal may be converted from ambient sound collected by the sound receiver 100, or may be input directly from the signal input unit 212 such as an audio port or a wireless communication module. The audio signal may be processed, such as being amplified or filtered by the signal processing unit 230, and then delivered to the speaker 240 and the transducer 217. In one embodiment, the transducer 217 may generate a variable magnetic field corresponding to the audio signal processed by the signal processing unit 230. The speaker 240 may generate a sound according to the same audio signal. Also, the transducer 217 may be disposed on the auricular part 221 of the housing 220 or on the wearable part 222 of the housing 220. In one embodiment, the transducer 217 may be disposed on the wearable part 222 so that the transducer 217 may be in close proximity to a user's scalp, within three centimeters or less. Also, the plane of the transducer 217 may be substantially parallel to the wearable part 222 so that a variable magnetic field generated by the transducer 217 may be substantially perpendicular to user's scalp. In one embodiment, a sound delivery device 200 may comprise a sound receiver 100, a signal input unit 212, a signal processing unit 230, a left speaker 240L, a right speaker 240R, a left transducer 217L, a right transducer 217R. and a housing 220. The sound delivery device 200 may receive ambient sound by the sound receiver 100 and audio signals from the signal input unit 212. Then, the signal processing unit 230 may mix signals from both the sound receiver 100 and the signal input unit 212. Subsequently, the signal processing unit 230 conveys the mixed audio signals to speakers 240 and transducers 217. Specifically, the audio signal received by the right transducer 217R may be the same as the audio signal received by the left speaker 240L and the audio signal received by the left transducer 217L may be the same as the audio signal received by the right speaker 240R. Also, the transducers 217 may be settled on the auricular part 221 of a housing 220 or on the wearable part 222 of a housing 220. Moreover, the audio signal received by the transducers 217 may have a designated phase delay such that the variable magnetic field generated by the transducers 217 may be later than the sound generated by the speakers 240 corresponding to the same audio signal. In some embodiments, the generating time of the variable magnetic field is later than the generating time of the sound by 0.0001-0.05 seconds. In certain embodiment, the generating time of the variable magnetic field is later than the generating time of the sound by 0.0125 seconds.

The present disclosure provides a transducer module and a sound delivery device to generate a variable magnetic field and a sound corresponding to the same audio signal, which may be applied in a hearing aid. Users wearing such hearing aid may experience improved sensitivity to sound. The embodiments mentioned above only describe a few embodiments of the present disclosure. The embodiments in detail should not be understood as a limitation to the scope of the present disclosure. It should be noted that, for one of the ordinary skill in the art, many variations and improvements can be made based on the present disclosure, which variations and improvements belong to the scope of the present disclosure.

What is claimed is:

1. A transducer module, comprising:
a signal input unit; and
at least one transducer,
wherein the signal input unit receives an audio signal and transmit the audio signal to the at least one transducer, and the at least one transducer comprises a coil configured for generating a variable magnetic field corresponding to the audio signal.

2. The transducer module of claim 1, wherein a diameter of the coil falls within a range of 1-5 centimeters.

3. The transducer module of claim 1, wherein an electrical resistance of the coil is 1800 ohm, and a working current carried by the coil falls within a range of 0-0.2 milliamperes.

4. The transducer module of claim 1, wherein planes formed by turns of the coil are substantially parallel to each other.

5. The transducer module of claim 1, wherein the signal input unit comprises a microphone, an audio port or a wireless communication module.

6. The transducer module of claim 1, further comprising a coupling circuit electrically connected to the signal input unit and at least one transducer.

7. The transducer module of claim 1, further comprising a housing for accommodating the at least one transducer and the signal input unit and for coupling the transducer module to a wearable headphone.

8. A sound delivery device, comprising:
a signal input unit, configured for receiving an audio signal and transmit the audio signal to the signal processing unit;
a signal processing unit, configured for processing the audio signal and transmit the processed audio signal to the at least one transducer and the at least one speaker respectively;
at least one transducer, comprising a coil configured for generating a variable magnetic field corresponding to the processed audio signal; and
at least one speaker, configured for generating a sound corresponding to the processed audio signal.

9. The sound delivery device of claim 8, wherein an electrical resistance of the coil is 1800 ohm, and a working current carried by the coil falls within a range of 0-0.25 milliamperes.

10. The sound delivery device of claim 8, wherein a diameter of the coil of the at least one transducer is greater than a diameter of a coil in the at least one speaker.

11. The sound delivery device of claim 8, further comprising a coupling circuit electrically connected to the signal processing unit and the at least one transducer, wherein the coupling circuit couples electrical characteristics of the at least one transducer with electrical characteristics of the at least one speaker.

12. The sound delivery device of claim 11, wherein the coupling circuit provides the processed audio signal with a predetermined phase delay.

13. The sound delivery device of claim 12, wherein the variable magnetic field generated by the at least one transducer is 0.001-0.05 seconds later than the sound generated by the at least one speaker.

14. The sound delivery device of claim 8, further comprising a sound receiver configured to receive ambient sound and convert the sound to input audio signals.

15. The sound delivery device of claim 14, further comprising a signal switch unit electrically connected to the sound receiver, the signal input unit and the signal processing unit, wherein the signal switch unit is configured to select a signal input source or a mode of the input audio signals from the sound receiver and the signal input unit, and transmit the selected signal input source or mode to the signal processing unit.

16. The sound delivery device of claim 14, wherein the signal processing unit is configured to mix the input audio signals from the sound receiver and the audio signal from the signal input unit.

17. The sound delivery device of claim 8, further comprising a housing to accommodate the signal input unit, the signal processing unit, the at least one transducer and the at least one speaker, wherein the housing comprises at least one auricular part and a head-wearable part, and the at least one speaker is integrated in the at least one auricular part of the housing.

18. The sound delivery device of claim 17, wherein the transducer is disposed on the at least one auricular part of the housing or the transducer is disposed on the head-wearable part of the housing.

19. The sound delivery device of claim 8, wherein the at least one transducer includes a left transducer and a right transducer, and the at least one speaker includes a left speaker and a right speaker.

20. The sound delivery device of claim 19, wherein the signal processing unit flips the processed audio signal received by the left transducer and the right transducer.

21. The sound delivery device of claim 19, wherein the processed audio signal received by the right transducer is identical to the processed audio signal received by the left speaker, and the processed audio signal received by the left transducer is identical to the processed audio signal received by the right speaker.
